(19) United States
(12) Patent Application Publication
(10) Pub. No.: US 2008/0278426 A1
(43) Pub. Date: Nov. 13, 2008

(54) Method and Apparatus for Driving LCD Panel for Displaying Image Data

(76) Inventors: Po-Tsun Chen, Hsinchu County (TW); Gin-Yen Lee, Hsinchu County (TW); Bin-Jung Tsai, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/838,880

(22) Filed: Aug. 14, 2007

(30) Foreign Application Priority Data
May 11, 2007 (TW) 096116775

(51) Int. Cl. G09G 3/36

(52) U.S. Cl. 345/96

(57) ABSTRACT

A method for driving an LCD panel for displaying image data includes generating a random code sequence including a plurality of random codes with values equal to a first value or a second value, generating a plurality of driving voltages corresponding to a plurality of pixels in the LCD panel according to the image data, adjusting polarities of the plurality of driving voltages according to the random code sequence, and driving the plurality of pixels with the plurality of driving voltages after polarity adjustment.

### BACKGROUND OF THE INVENTION

1. Field of the Invention

The present invention is related to a method and apparatus for driving an LCD panel to display image data, and more particularly, to a method and apparatus capable of changing polarities of driving voltages of pixels in the LCD panel according to a random code sequence, so as to avoid frame flickers.

2. Description of the Prior Art

A liquid crystal display (LCD) monitor has characteristics of light shape, low power consumption, zero radiation, etc., and has been widely used in many information technology (IT) products, such as computer systems, mobile phones, and personal digital assistants (PDAs). The operating principle of the LCD is based on a property that liquid crystals in different twist status can exert different polarization and refraction effects on light. Thus, the liquid crystals arranged in different twist statuses control penetration amount of light so that various intensities of output light and red, green and blue lights in diverse gray levels can be produced.

Please refer to FIG. 1, which illustrates a schematic diagram of a prior art thin film transistor (TFT) LCD monitor 10. The LCD monitor 10 includes an LCD panel 100, a control circuit 102, a data-line-signal output circuit 104, a scan-line-signal output circuit 106, and a voltage generator 108. The LCD panel 100 is formed with two substrates, and there are LCD layers stuffed between the substrates. One substrate includes a plurality of data lines 110, a plurality of scan lines (or gate lines) 112 vertical to the data lines 110, and a plurality of TFTs 114. The other substrate includes a common electrode for providing a common voltage Vcom generated by the voltage generator 108. For the sake of brevity, FIG. 1 only reveals four TFTs 114, but in a real case, each of TFTs 114 is set at an intersection of a data line 110 and a scan line 112 on the LCD panel 100. In other words, the plurality of TFTs 114, each corresponding to a pixel, form a matrix on the LCD panel 100, and thereby the data lines 110 and the scan lines 112 are corresponding to columns and rows of the matrix. In addition, a circuit effect resulted from the two substrates of the LCD panel 100 can be regarded as equivalent capacitors 116.

A driving process of the prior art TFT LCD monitor 10 is described in detail as follows. When the control circuit 102 receives a horizontal synchronization signal 118 and a vertical synchronization signal 120, the control circuit 102 generates corresponding control signals for the data-line-signal output circuit 104 and the scan-line-signal output circuit 106. The data-line-signal output circuit 104 and the scan-line-signal output circuit 106 generate input signals for the data lines 110 and the scan lines 112 according to the control signals, in order to control the TFTs 114 and voltage differences of the equivalent capacitors 116. The voltage differences change twists of liquid crystals and corresponding penetration amounts of light, so as to display the display data 122 on a panel. For example, the scan-line-signal output circuit 106 outputs a pulse wave for switching on the TFTs 114, and signals of a corresponding data line 110 outputted from the data-line-signal output circuit 104 can pass through the TFTs 114 to the corresponding equivalent capacitors 116, so as to control gray levels of corresponding pixels. Besides, controlling signal levels of the signals of the data line 110 outputted from the data-line-signal output circuit 104 can generate different gray levels.

If the LCD monitor 10 continuously uses a positive voltage to drive the liquid crystal molecules, the liquid crystal molecules will not quickly change the alignment, so that the incident light will not produce accurate polarization or refraction, and image quality deteriorates. Similarly, if the LCD monitor 10 continuously uses a negative voltage to drive the liquid crystal molecules, the incident light will not produce accurate polarization or refraction. In order to protect the liquid crystal molecules from being irregular, the LCD monitor 10 must alternately use positive and negative voltages to drive the liquid crystal molecules. In addition to the equivalent capacitors 116, there are parasite capacitors in circuits. When an image is displayed on the LCD panel 100 for a long time, the parasite capacitors will be charged to generate a residual image effect. The residual image with regard to the parasite capacitors will further distort the following images displayed on the same LCD panel 100. Therefore, the LCD monitor 10 must alternately use the positive and negative voltages to drive the liquid crystal molecules for eliminating the undesired residual image effect. Please refer to FIGS. 2-5, FIG. 15 and FIG. 16. FIG. 2 and FIG. 3 are schematic diagrams of a prior art frame inversion driving method, FIG. 4 and FIG. 5 are schematic diagrams of a prior art line inversion driving method, and FIG. 15 and FIG. 16 are diagrams of a prior art dot inversion driving method. Blocks 20 and 30, blocks 40 and 50, and blocks 150 and 160 show polarities of pixels in the same part of two successive frames.

Known from FIG. 2 and FIG. 3, when driving the LCD panel 100 through the frame inversion driving method, polarities of pixels in a frame (at the same time) are uniform and change to opposite polarities as a frame changes. However, the frame inversion driving method produces flickers between frames due to a voltage offset formed by the TFTs 114. In comparison, when driving the LCD panel 100 through the line inversion driving method, polarities of pixels in a line are uniform, and change to opposite polarities as a frame changes. Also, polarities of two adjacent lines are different, so that the line inversion can decrease the frame flickers. Therefore, the line inversion driving method has a better image quality, but the line inversion driving method forms uneven brightness between lines due to the voltage offset formed by the TFTs 114. Besides, the power consumption of the line inversion driving method is much more than that of the frame inversion driving method, which limits the application range, especially on portable electronic devices with LCD panels.

### SUMMARY OF THE INVENTION

It is therefore a primary objective of the claimed invention provides a method and apparatus for driving an LCD panel for displaying image data.

The present invention discloses a method for driving a liquid crystal display (LCD) panel for displaying image data, which comprises generating a random code sequence comprising a plurality of random codes with values equal to a first value or a second value, generating a plurality of driving voltages corresponding to a plurality of pixels in the LCD panel according to the image data, adjusting polarities of the plurality of driving voltages according to the random code sequence, and driving the plurality of pixels with the plurality of driving voltages after the polarity adjustment.

The present invention further comprises a driving apparatus for driving an LCD panel and displaying image data, which comprises a random code generator, for generating a random code sequence comprising a plurality of random codes, with values of a first value or a second value, a driving voltage generating unit, for generating a plurality of driving voltages corresponds to a plurality of pixels in the LCD panel according the image data, a polarity adjustment unit coupled to the random code generator and the driving voltage generating unit, for adjusting polarities of the plurality of driving voltages generated from the driving voltage generating unit according to the random code sequence, and a driving voltage outputting unit coupled to the polarity adjustment unit, for driving the plurality of pixels with the plurality of driving voltages after the polarity adjustment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art thin film transistor liquid crystal display monitor.

FIG. 2 and FIG. 3 are schematic diagrams of a prior art frame inversion driving procedure.

FIG. 4 and FIG. 5 are schematic diagrams of a prior art line inversion driving procedure.

FIG. 6 illustrates a schematic diagram of a procedure according to an embodiment of the present invention.

FIG. 7 illustrates a schematic diagram of a driving apparatus according to an embodiment of the present invention.

FIG. 8, FIG. 9, FIG. 10 and FIG. 12 illustrate schematic diagrams of linear feedback shift registers.

FIG. 11 illustrates a schematic diagram of an output unit corresponding to the linear feedback shift register shown in FIG. 10.

FIG. 13 and FIG. 14 illustrate schematic diagrams of output units corresponding to the linear feedback shift register shown in FIG. 12.

FIG. 15 and FIG. 16 are schematic diagrams of a prior art frame inversion driving procedure.

FIG. 17 illustrates a schematic diagram of driving voltage polarities of a line of pixels in an embodiment of the present invention that are set according to random code values.

### DETAILED DESCRIPTION

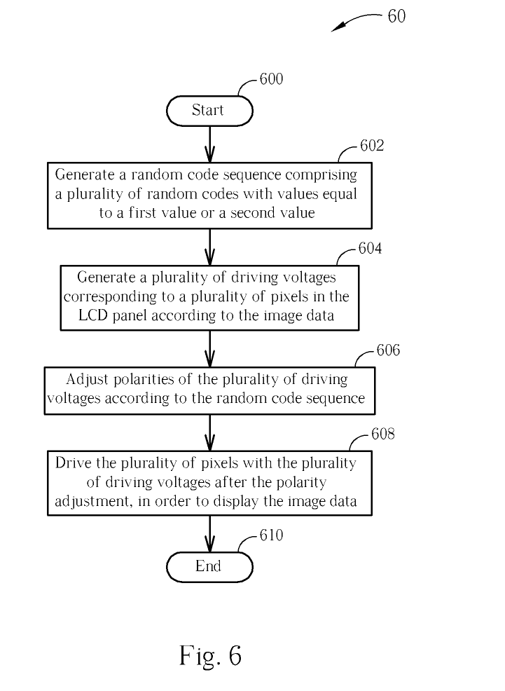

Please refer to FIG. 6, which illustrates a schematic diagram of a procedure 60 according to an embodiment of the present invention. The process 60 is utilized for driving an LCD panel to display image data, which includes the following steps:

Step 600: Start.

Step 602: Generate a random code sequence comprising a plurality of random codes with values equal to a first value or a second value.

Step 604: Generate a plurality of driving voltages corresponding to a plurality of pixels in the LCD panel according to the image data.

Step 606: Adjust polarities of the plurality of driving voltages according to the random code sequence.

Step 608: Drive the plurality of pixels with the plurality of driving voltages after the polarity adjustment, in order to display the image data.

Step 610: End

Hence, the procedure 60 of the present invention adjusts polarities of driving voltages for driving pixels of the LCD panel according to the random code sequence formed by the first value and the second value, and drives the pixels with the adjusted driving voltages. In other words, the polarities of the driving voltages are adjusted according to the random code sequence. As those skilled in the art recognized, an ideal random code sequence is unpredictable, and appearance times of each value are the same, so that polarities of the pixels do not regularly switch between two adjacent frames, and positive and negative polarities of each pixel appear the same times. Under this condition, when the procedure 60 drives the LCD panel to display image data, the present invention can not only avoid the frame flickers, but also solve the uneven brightness between lines.

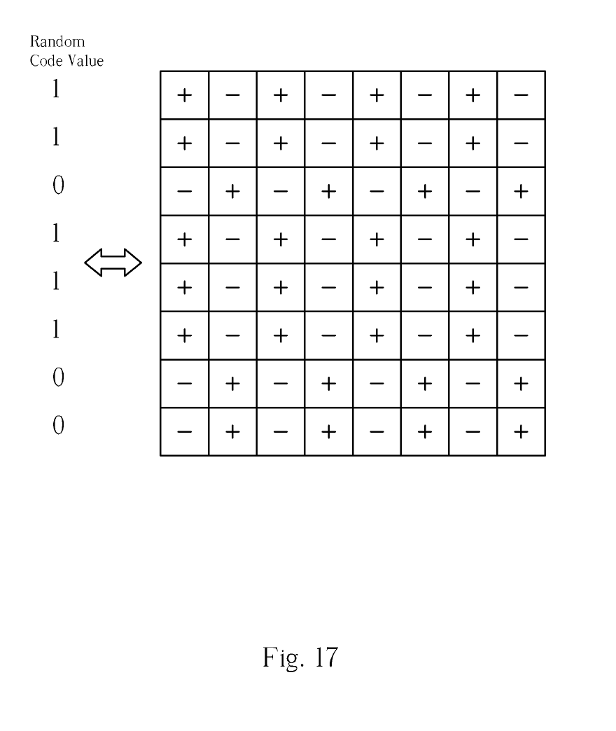

Preferably, the first value is 1 and the second value is 0. The step 604 can correspond each random code of the random code sequence to each row of the LCD panel, and adjusts polarities of driving voltages of pixels in a row of the LCD panel according to a random code corresponding to the row. In other words, the present invention can set polarities of driving voltages corresponding to pixels in the same row as the same, and correspond them to a random code, and adjust the polarities of the driving voltages according to values of the random code. For instance, if a value of a random code corresponding to a row is 1, then pixels in the row are driven by a positive driving voltage; if the value of the random code corresponding to the row is 0, then the pixels in the row are driven by a negative driving voltage. Under this condition, the polarities of the driving voltages corresponding to the pixels in each row change randomly. Consequently, the pixels in the same row do not regularly switch polarities between adjacent frames, and can avoid uneven brightness. Besides, the present invention can also set polarity arrangements of driving voltages for driving pixels in each row, and each arrangement are corresponding to a random code. For example, when a value of a random code corresponding to pixels in a row is 1, polarities of driving voltages for driving the pixels in the row are set to be switched alternately (as the dot inversion) starting from positive. Oppositely, when the value of the random code is 0, the polarities of the driving voltages for driving the pixels in the row are set to be switched alternately starting from negative, as shown in FIG. 17.

As those skilled in the art recognized, an ideal random code sequence is unpredictable, and each value is generated for the same times. However, a huge calculation is required to generate the ideal random code sequence. Therefore, the present invention can generate a random code sequence through generating cyclic pseudo random codes or pseudo noise codes, such as generating pseudo random codes through a characteristic polynomial. Under this condition, the calculation for generating the random code sequence can be reduced, in order to save system resources.

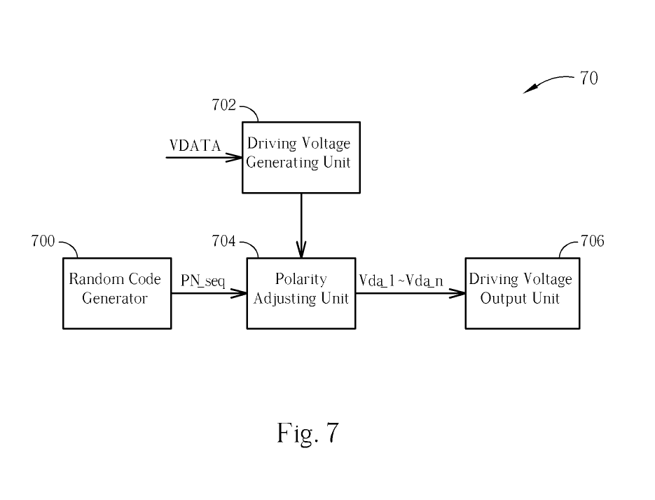

Please refer to FIG. 7, which illustrates a schematic diagram of a driving apparatus 70 according to an embodiment of the present invention. The driving apparatus 70 realizes the procedure 60, to drive a LCD panel to display an image data VDATA. The driving apparatus 70 includes a random code generator 700, a driving voltage generating unit 702, a polarity adjusting unit 704, and a driving voltage output unit 706. The random code generator 700 is utilized for generating a random code sequence PN_seq composed of 1 and 0. The driving voltage generating unit 702 generates driving voltages Vd_1˜Vd_n corresponding to the pixels in the LCD panel according to the image data VDATA. The polarity adjusting unit 704 is coupled to the random code generator 700 and the driving voltage generating unit 702, and utilized for adjusting the polarities of the driving voltages Vd_1˜Vd_n according to the random code sequence PN_seq, so as to generate driving voltages Vda_1˜Vda_n. The driving voltage output unit 706 is coupled to the polarity adjusting unit 704, and utilized for driving corresponding pixels using the driving voltages Vda_1˜Vda_n, so as to display the image data.

Hence, in the driving apparatus 70, the polarity adjusting unit 704 can adjust the polarities of the driving voltages Vd_1˜Vd_n generated by the generating unit 702 according to the random code sequence PN_seq generated by the random code generator 700, to output the driving voltages Vda_1˜Vda_n, and the driving voltage output unit 706 can drive corresponding pixels with the driving voltages Vda_1˜Vda_n. In other words, the polarities of the driving voltages are switched according to the random code sequence. Since the ideal random code sequence is unpredictable, and each value is generated for the same times, the pixels of the LCD panel do not regularly switch polarities between adjacent frames, and positive and negative polarities of each pixel appear the same times. Under this condition, when the driving apparatus 70 of the present invention drives the LCD panel to display the image data, frame flickers can be avoided, and uneven brightness between rows are solved.

Preferably, the polarity adjusting unit 704 can correspond each random code of the random code sequence PN_seq to each row of the LCD panel, and adjust polarities of driving voltages of pixels in a row of the LCD panel according to a random code corresponding to the row. That is to say, the present invention can set polarities of driving voltages of pixels in the same row as the same, and correspond them to a random code, and adjust the polarities of the driving voltages according to values of the random code. For example, if a value of a random code corresponding to a row is 1, then pixels in the row are driven by a positive driving voltage; if a value of a random code corresponding to another row is 0, then pixels in the row are driven by a negative driving voltage. Under this condition, the polarities of the driving voltages corresponding to the pixels in each row change randomly. Hence, pixels in the same row do not regularly switch polarities between adjacent frames, and can avoid the uneven brightness between rows.

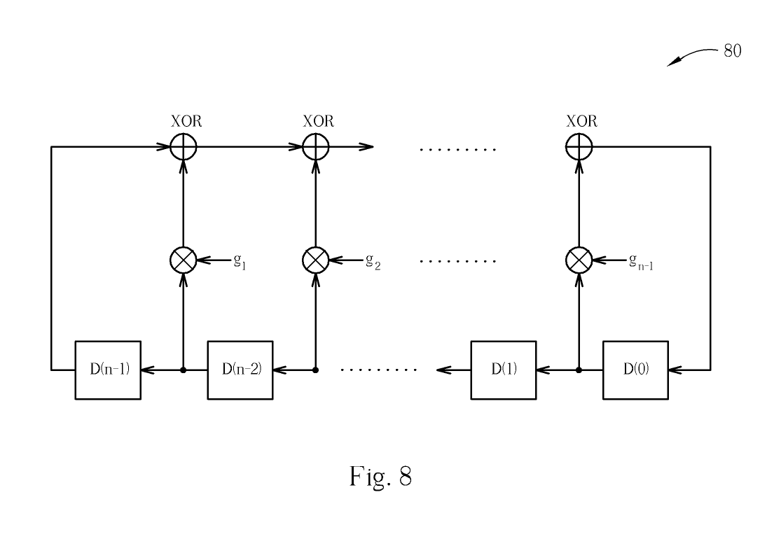

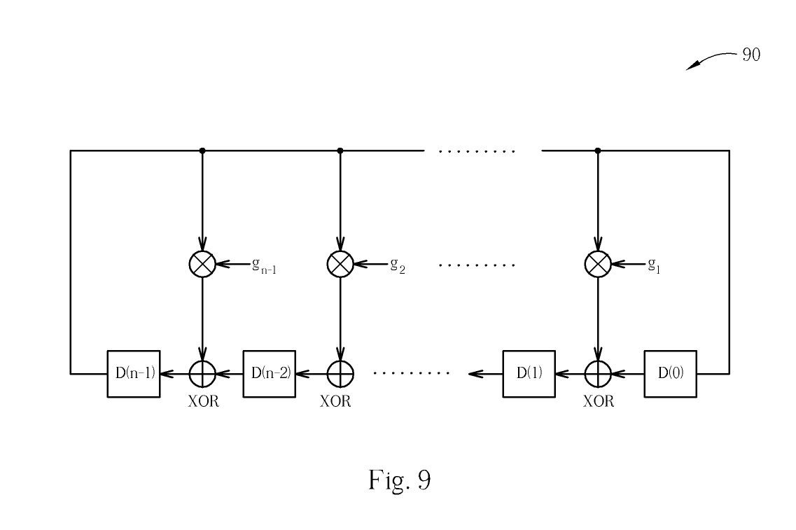

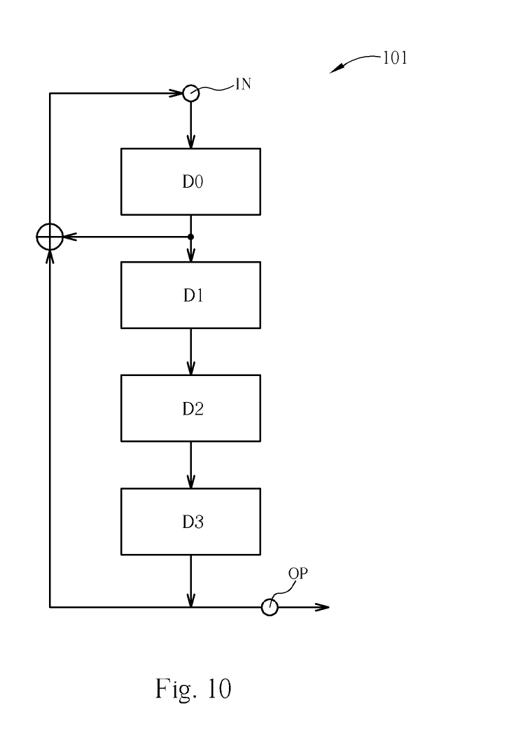

As those skilled in the art recognized, an ideal random code sequence is unpredictable, and each value is generated for the same times. However, a huge calculation is required to generate the ideal random code sequence. Therefore, the present invention can realize the random code generator 700 through a linear feedback shift register, to generate cyclic pseudo random codes or pseudo noise codes, in order to save system resources. For example, please refer to FIG. 8 and FIG. 9, which illustrate schematic diagrams of linear feedback shift registers 80 and 90. The linear feedback shift registers 80 and 90 are all formed by shift registers D(0)˜D(n-1) and exclusive OR gates (XOR), while the XOR gates of the linear feedback shift register 80 are set outside a loop of the shift registers D(0)˜D(n-1), and the XOR gates of the linear feedback shift register 90 are set inside the loop of the shift registers D(0)˜D(n-1). Both realize a characteristic polynomial:

g(x)=gₙxⁿ+gₙ₋₁xⁿ⁻¹+ . . . +g₀x⁰

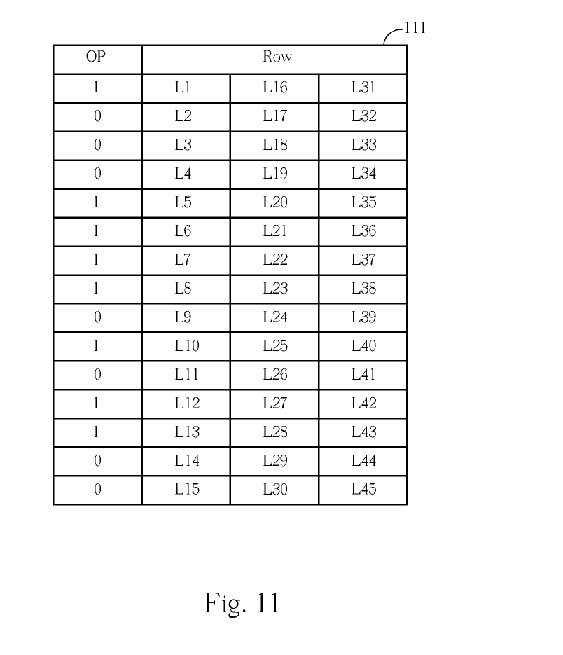

Note that, the linear feedback shift registers 80 and 90 shown in FIG. 8 and FIG. 9 are embodiments of the random code generator 700 in FIG. 7, for generating cyclic pseudo random codes, and those skilled in the art can modify the structure of the linear feedback shift registers 80 and 90 according to required characteristic polynomials, or replace with other random code generators, to generate specific cyclic random code sequences, for references of adjusting the polarities of the driving voltages by the polarity adjusting unit 704. For instance, if the required characteristic polynomial is (X⁴+x³+1), the random code generator can be realized through a linear feedback shift register 101 as shown in FIG. 10. The structure of the linear feedback shift register 101 resembles the linear feedback shift register 80 shown in FIG. 8, which outputs a 15-bit-cycle random code sequence from an output end OP according to the initial data (0,0,0,1) inputted to a start end IN. Afterwards, by corresponding the random code sequence outputted from the linear feedback shift register 101 to each row in the LCD panel sequentially, a chart 111 shown in FIG. 11 can be obtained. In the chart 111, L1˜L45 represent the rows of the LCD panel. According to the chart 111, the polarity adjusting unit 704 can adjust the polarities of the driving voltages of pixels in each row of the LCD panel, for example, drive the first, fifth, sixth . . . row with the positive driving voltage, and drive the second, third, fourth, ninth . . . row with the negative voltage. In this way, the pixels in the same row do not regularly switch polarities between adjacent frames, and can avoid uneven brightness between rows.

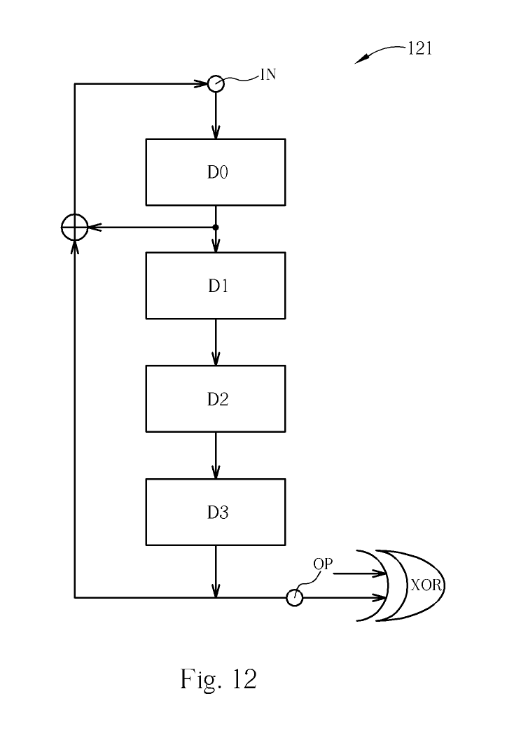

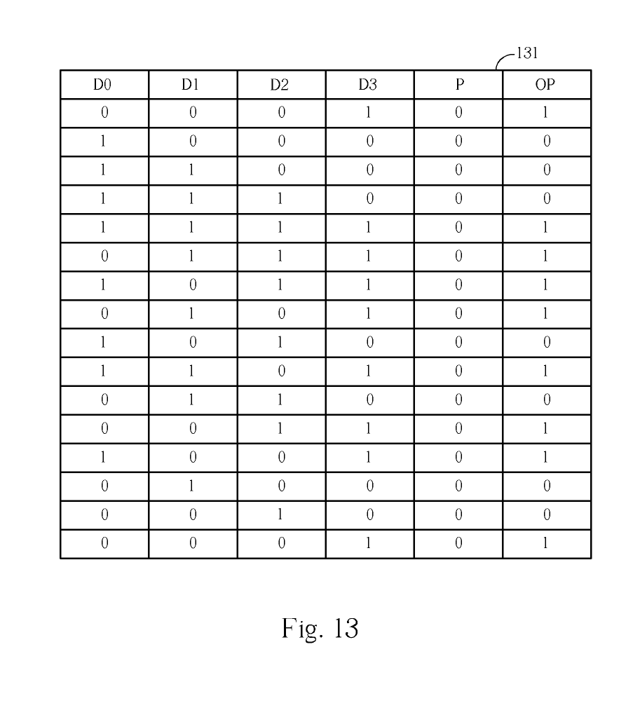

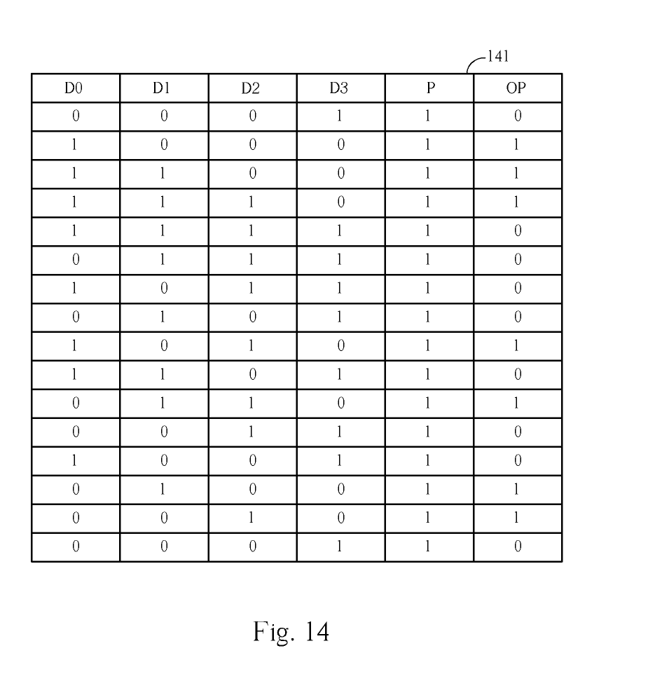

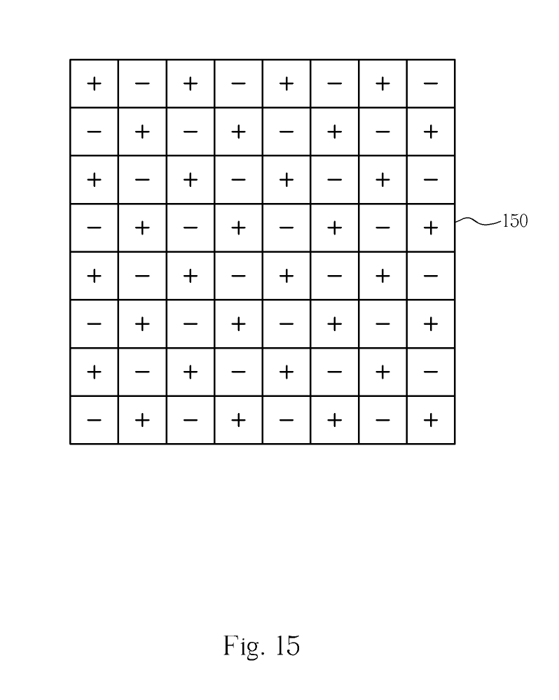

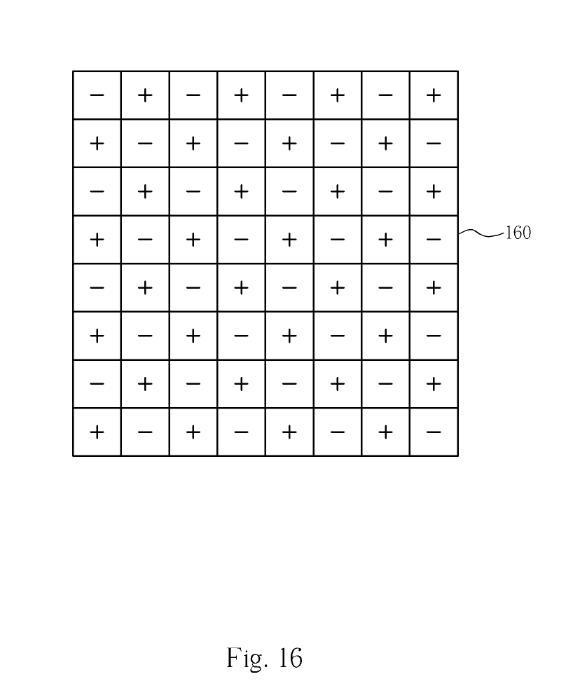

As shown in the chart 111, the random code sequence outputted from the linear feedback shift register 101 has a cycle of 15 bits, which includes eight 1s and seven 0s. Under this condition, the appearance times of the positive driving voltages is once more than that of the negative driving voltages, which may result in uneven brightness. In order to solve the problem above, the present invention can cascade an XOR gate to the output end OP of the linear feedback shift register 101, which forms a linear feedback shift register 121 shown in FIG. 12. In the linear feedback shift register 121, a signal P generated by a signal generating unit (not shown in FIG. 12) cyclically switches between 0 and 1, so that the output bits corresponding to the linear feedback shift register 121 switch as charts 131 and 141 shown in FIG. 13 and FIG. 14. The charts 131 and 141 are corresponding to two adjacent cycles, including eight 1s, seven 0s and seven 1s, eight 0s; therefore, there are fifteen 1s and fifteen 0s in total. In other words, between adjacent cycles, the appearance times of the positive driving voltages are the same as that of the negative driving voltages, so as to avoid uneven brightness. Certainly, there are many ways to generate cyclic pseudo random codes, and the linear feedback shift register mentioned above is merely an embodiment, not a limitation.

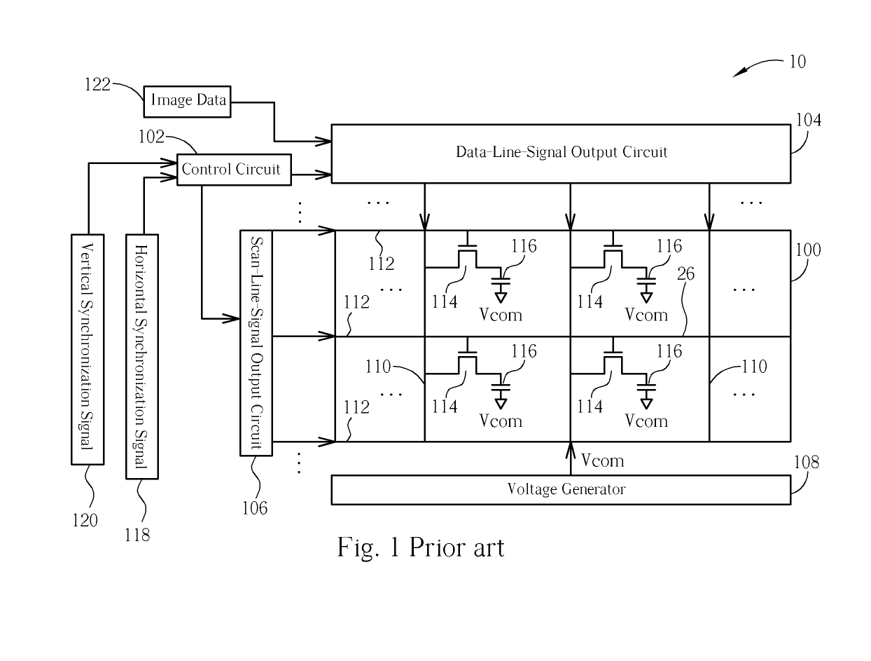

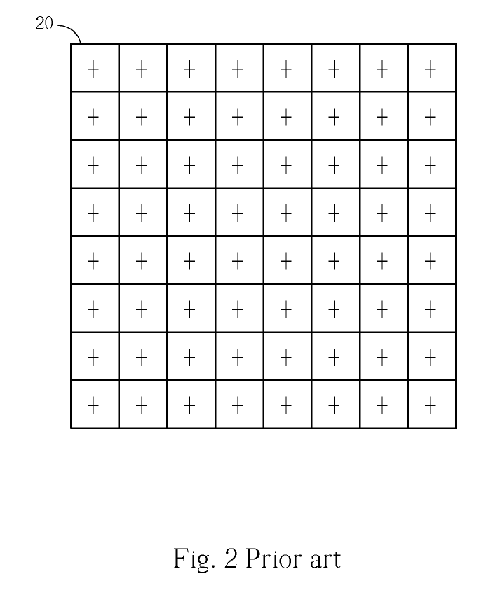

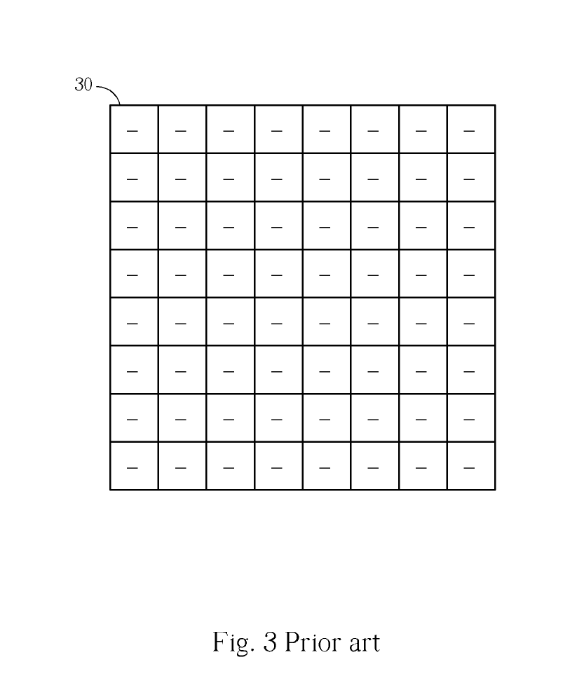

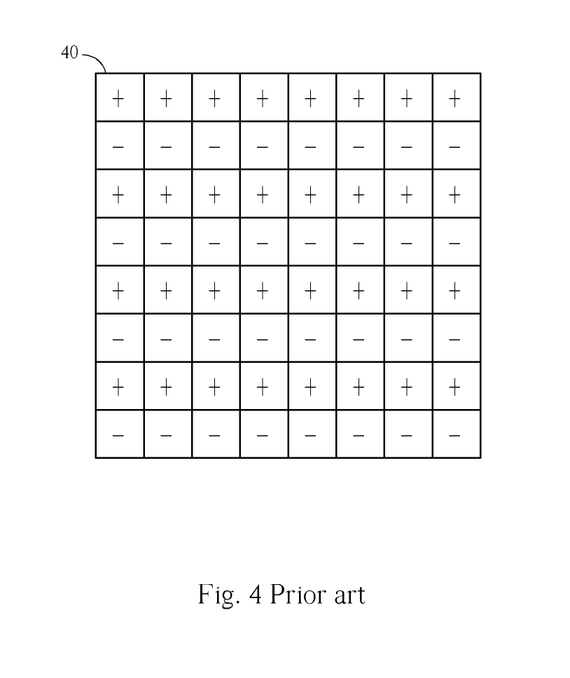

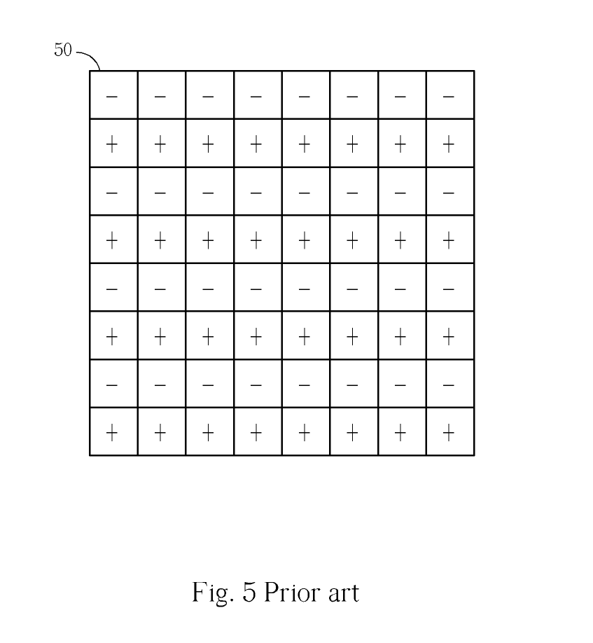

When realizing the driving apparatus 70 of the present invention, those skilled in the art can make modifications, such as integrating the driving voltage generating unit 702, the polarity adjusting unit 704 and the driving voltage output unit 706 into the data-line-signal output circuit and the voltage generator shown in FIG. 1, to simplify the design.

As a conclusion, the present invention changes the polarities of the driving voltages for driving the pixels in the LCD panel according to the random code sequence. Since an ideal random code sequence is unpredictable, and each value is generated the same times, when driving the pixels in the LCD panel with the present invention, the pixels of the LCD panel do not regularly switch polarities between adjacent frames, and the appearance times of the positive driving voltages are the same as that of the negative driving voltages, which not only avoid frame flickers, but also solve the uneven brightness between rows.

Those skilled in the art will readily observe that numerous modifications and alterations of the device and method may be made while retaining the teachings of the invention.

What is claimed is:

1. A method for driving a liquid crystal display (LCD) panel for displaying image data comprising:
generating a random code sequence comprising a plurality of random codes with values equal to a first value or a second value;
generating a plurality of driving voltages corresponding to a plurality of pixels in the LCD panel according to the image data;
adjusting polarities of the plurality of driving voltages according to the random code sequence; and
driving the plurality of pixels with the plurality of driving voltages after the polarity adjustment, in order to display the image data.

2. The method of claim 1, wherein adjusting the polarities of the plurality of driving voltages according to the random code sequence is corresponding each random code of the random code sequence to each row of the LCD panel, and adjusting polarities of driving voltages of the plurality of driving voltages, corresponding to pixels of the rows of the LCD panel, according to values of the random codes corresponding to the rows of the LCD panel.

3. The method of claim 2, wherein adjusting the polarities of the driving voltages corresponding to the pixels of the rows of the LCD panel according to the values of the random codes corresponding to the rows of the LCD panel is setting a polarity of a pixel voltage driving a first row of the LCD panel to be positive when a value of a random code corresponding to the first row is the first value, and setting a polarity of a pixel voltage driving a second row to be negative when a value of a random code corresponding to the second row is the second value.

4. The method of claim 1, wherein the random code sequence is periodically cyclic.

5. The method of claim 4 further comprising switching random codes of the first value to the second value, and switching random codes of the second value to the first value during adjacent cycles of the random code sequence.

6. The method of claim 1, wherein the first value is 1, and the second value is 0.

7. A driving apparatus for driving an LCD panel and displaying image data comprising:
a random code generator, for generating a random code sequence comprising a plurality of random codes, with values of a first value or a second value;
a driving voltage generating unit, for generating a plurality of driving voltages corresponds to a plurality of pixels in the LCD panel according the image data;
a polarity adjustment unit coupled to the random code generator and the driving voltage generating unit, for adjusting polarities of the plurality of driving voltages generated from the driving voltage generating unit according to the random code sequence; and
a driving voltage outputting unit coupled to the polarity adjustment unit, for driving the plurality of pixels with the plurality of driving voltages after the polarity adjustment.

8. The driving device of claim 7, wherein the polarity adjustment unit corresponds each random code of the random code sequence to each row of the LCD panel, and adjusts polarities of driving voltages of the plurality of driving voltages, corresponding to pixels of the rows of the LCD panel, according to values of the random codes corresponding to the rows of the LCD panel.

9. The driving device of claim 8, wherein the polarity adjustment unit sets a polarity of a pixel voltage driving a first row of the LCD panel to be positive when a value of a random code corresponding to the first row is the first value, and sets a polarity of a pixel voltage driving a second row to be negative when a value of a random code corresponding to the second row is the second value.

10. The driving device of claim 7, wherein the random code generator is a linear feedback shift register for generating the periodically cyclic random code sequence.

11. The driving device of claim 7, wherein the random code generator comprises:
an input end for receiving an enable signal;
an output end for outputting the random code sequence;
a shift register sequence coupled between the input end and the output end, comprising a sequence of shift registers; and
a first exclusive OR operation unit comprising a first end coupled to the output end, a second end coupled between adjacent shift registers of the shift register sequence, and a third end coupled to the input end, for outputting an exclusion OR result of data received from the first end and the second end through the third end.

12. The method of claim 11, wherein the random code generator further comprises:
a signal generating unit for switching outputs of a third value and a fourth value according to a cycle of the random code sequence;
a second exclusive OR operation unit comprising a first end coupled to the signal generating unit, a second end coupled to the output end of the random code generator, and a third end coupled to the driving voltage generating unit, for outputting an exclusion OR result of data received from the first end and the second end through the third end.

13. The method of claim 12, wherein the third value is 1, and the fourth value is 0.

14. The method of claim 10, wherein the random code generator comprises:
an input end for receiving an enable signal;
an output end for outputting the random code sequence;
a shift register sequence between the input end and the output end, comprising a sequence of shift registers; and
a first exclusive OR operation unit comprising a first end coupled to the output end and the start end, a second end coupled to a first shift register of the shift register sequence, and a third end coupled to a second shift register adjacent to the first shift register, for outputting an exclusion OR result of data received from the first end and the second end through the third end.

15. The method of claim 14, wherein the random code generator further comprises:
a signal generating unit for switching outputs of a third value and a fourth value according to a cycle of the random code sequence;
a second exclusive OR operation unit comprising a first end coupled to the signal generating unit, a second end coupled to the output end of the random code generator, and a third end coupled to the driving voltage generating unit, for outputting an exclusion OR result of data received through the first end and the second end through the third end.

16. The method of claim 15, wherein the third value is 1, and the fourth value is 0.

17. The method of claim 7, wherein the first value is 1, and the second value is 0.
